(19) United States
(12) Patent Application Publication
(10) Pub. No.: US 2026/0311309 A1
(43) Pub. Date: Oct. 8, 2026

(54) COMPONENT IMAGING FOR DAMAGE DETECTION

(71) Applicant: Lenovo (United States) Inc., Morrisville, NC (US)

(72) Inventors: Lucas Cabral Carneiro da Cunha, Fortaleza (BR); Javam de Castro Machado, Fortaleza (BR); Daniel Cesar Felisberto Rezende, Indaiatuba (BR)

(21) Appl. No.: 19/169,444

(22) Filed: Apr. 3, 2025

(51) Int. Cl. G06T 7/00; G06T 3/4046; G06T 7/70; H04N 23/60; H04N 23/63

(52) U.S. Cl. CPC G06T 7/0002; G06T 3/4046; G06T 7/70; H04N 23/632; H04N 23/633; H04N 23/64; G06T 2207/20132; G06T 2207/30168

(57) ABSTRACT

One embodiment provides a method, the method including: receiving, at a component imaging system, an indication of an activation of an image capture device, wherein the activation includes a preview of an image to be taken of a component; obtaining, responsive to identifying that the position of the component within the frame meets a set of positioning rules, the image of the component; generating, using the component imaging system, a focused image by cropping the image; creating, using the component imaging system, a set of images, each of the images within the set of images including a respective portion of the focused image that is omitted from other images of the set of images; and transmitting, using the component imaging system, the set of images to a damage detection system. Other aspects are claimed and described.

### BACKGROUND

Devices have many different components that allow the device to perform the desired functions. For example, laptop computers have motherboards, memory, processors, display components, keyboards, and/or the like. When components get damaged, functions of the device may no longer be performed or the device itself may no longer work. If the damage can be identified, then correct components may be replaced so that the device can return to normal functioning. Thus, the accurate detection of damage is important to get the device functioning normally as quickly as possible. Additionally, for entities that may provide warranties for devices, it can often be important to accurately identify the damage to determine if the damage was caused by the user or if the damage is due to a cause that is covered under the warranty.

### BRIEF SUMMARY

In summary, one aspect provides a method, the method including: receiving, at a component imaging system, an indication of an activation of an image capture device, wherein the activation includes a preview of an image to be taken of a component; obtaining, responsive to identifying that the position of the component within the frame meets a set of positioning rules, the image of the component; generating, using the component imaging system, a focused image by cropping the image; creating, using the component imaging system, a set of images, each of the images within the set of images including a respective portion of the focused image that is omitted from other images of the set of images; and transmitting, using the component imaging system, the set of images to a damage detection system.

Another aspect provides a system, the system including: a processor; a memory device that stores instructions that, when executed by the processor, causes the system to: receive, at a component imaging system, an indication of an activation of an image capture device, wherein the activation includes a preview of an image to be taken of a component; obtain, responsive to identifying that the position of the component within the frame meets a set of positioning rules, the image of the component; generate, using the component imaging system, a focused image by cropping the image; create, using the component imaging system, a set of images, each of the images within the set of images including a respective portion of the focused image that is omitted from other images of the set of images; and transmit, using the component imaging system, the set of images to a damage detection system.

A further aspect provides a product, the product including: a computer-readable storage device that stores executable code that, when executed by a processor, causes the product to: receive, at a component imaging system, an indication of an activation of an image capture device, wherein the activation includes a preview of an image to be taken of a component; obtain, responsive to identifying that the position of the component within the frame meets a set of positioning rules, the image of the component; generate, using the component imaging system, a focused image by cropping the image; create, using the component imaging system, a set of images, each of the images within the set of images including a respective portion of the focused image that is omitted from other images of the set of images; and transmit, using the component imaging system, the set of images to a damage detection system.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SE4VERAL VIEWS OF THE DRAWINGS

FIG. 1 illustrates an example of information handling device circuitry.

FIG. 2 illustrates another example of information handling device circuitry.

FIG. 3 illustrates an example method for creating a set of images from an image of a component that conforms to positioning rules and that can be transmitted to a damage detection system while maintaining a resolution of the image so that damage of the component can be more accurately detected.

FIG. 4 illustrates an example image captured of a component with a background.

FIG. 5A illustrates an example generated focused image created from the example of FIG. 4.

FIG. 5B illustrates an example set of images created from the focused image of FIG. 5A.

### DETAILED DESCRIPTION

To more accurately identify damage to components and, therefore, determine a cause of the damage, the use of artificial intelligence models for damage detection has increased. The artificial intelligence models are able to analyze images of the component to identify damage to the component, even if the damage is small. The use of such artificial intelligence models can reduce the amount of time it takes to identify the damage to a component. Additionally, the models may more accurately identify the damage, particularly when there are multiple damage areas. The artificial intelligence models may also be able to more accurately identify a cause of the damage, meaning the models may be able to identify if the damage is caused by a user, caused by a defective component, caused by defective workmanship, and/or the like.

The artificial intelligence model detects the damage via pictures of the component. In other words, images of component are captured and provided to the model. The model then analyzes the images to identify the damage to the component. The problem is that the accuracy of the model is affected by the quality of the images of the component that are captured. Images that are too far away, fail to capture the whole component, that include glare, have poor resolution, include too much background, and/or the like, can result in damage being undetectable, incorrectly identified, and/or the like, by the artificial intelligence model. Additionally, when images are provided to the model, the model system typically rescales the image to a particular size due to processing and communication constraints. This rescaling can result in a change to the resolution of the image, generally to a poorer resolution. When the resolution of the image is changed, damage on the component may become more difficult or impossible to detect within the image. The traditional methods for addressing these issues are to rely on the user to take good pictures, which may include training a technician or other person who may be capturing the images and providing them to the model. However, this results in inconsistent image capture and typically does not fully address the issues with the image capturing.

Accordingly, the described system and method provides a technique for creating a set of images from an image of a component that conforms to positioning rules and that can be transmitted to a damage detection system while maintaining a resolution of the image so that damage of the component can be more accurately detected. The component imaging system receives an indication of an activation of an image capture device. The activation includes a preview of an image to be taken of a component. Thus, the indication may be the activation of the image capture device and the detection of a component within the image preview.

The component image system then obtains the image of the component responsive to identifying that the position of the component within the frame meets a set of positioning rules. The set of positioning rules may be rules that identify how the component should be positioned within a captured image so that the damage detection system can more accurately identify damage of the component. Thus, the set of positioning rules may identify a distance between the component and the image capture device, a tilt or angle of the image capture device with respect to the component, a size or completeness of the component within an obtained image, and/or the like. The positioning rules can change based upon different characteristics of the component, for example, a size of the component, a type of component, a color of the component, a background of the component, a type of damage, a size of damage, and/or the like.

From the obtained image, the component imaging system generates a focused image. The focused image is an image where the background has been removed. Thus, the focused image may be an image where the background has been processed out from the image, may be a cropped image where the image is cropped to within a predetermined threshold distance from the component, and/or the like, or a combination thereof. From the focused image, the system creates a set of images, with each of the images being a portion of the focused image. Each of the images within the set of images maintains the original resolution of the obtained image, while resizing each of the images to conform with the size or scale requirements of the damage detection system. Once the set of images are created, these can be transmitted to the damage detection system for damage detection.

Therefore, a system provides a technical improvement over traditional methods for component image capture. The described system can provide feedback to the user capturing the images, so that the component(s) can be correctly positioned within the frame of the image that is captured. This results in a more consistent image that can be provided to a damage detection system, thereby resulting in more accurate damage detection. Additionally, the described system is able to create a focused image to reduce the amount of image noise within the image. This allows the damage detection system to be more accurate and reduces the occurrences where the model incorrectly identifies damage in portions of the image that do not correspond with the component.

The system also creates a set of images from the focused image. The set of images are of a fixed size as required by the damage detection system. However, by creating the set of images before the images are provided to the damage detection system, the described system is able to maintain the resolution of the images. Thus, the images provided to the damage detection system have an increased resolution as compared to the resolution that the damage detection system would create. Accordingly, the described system is able to create a set of images that are properly positioned, have less image noise, and maintain the image resolution as compared to traditional techniques, thereby allowing the damage detection system to more accurately identify damage of a component.

The illustrated example embodiments will be best understood by reference to the figures. The following description is intended only by way of example, and simply illustrates certain example embodiments.

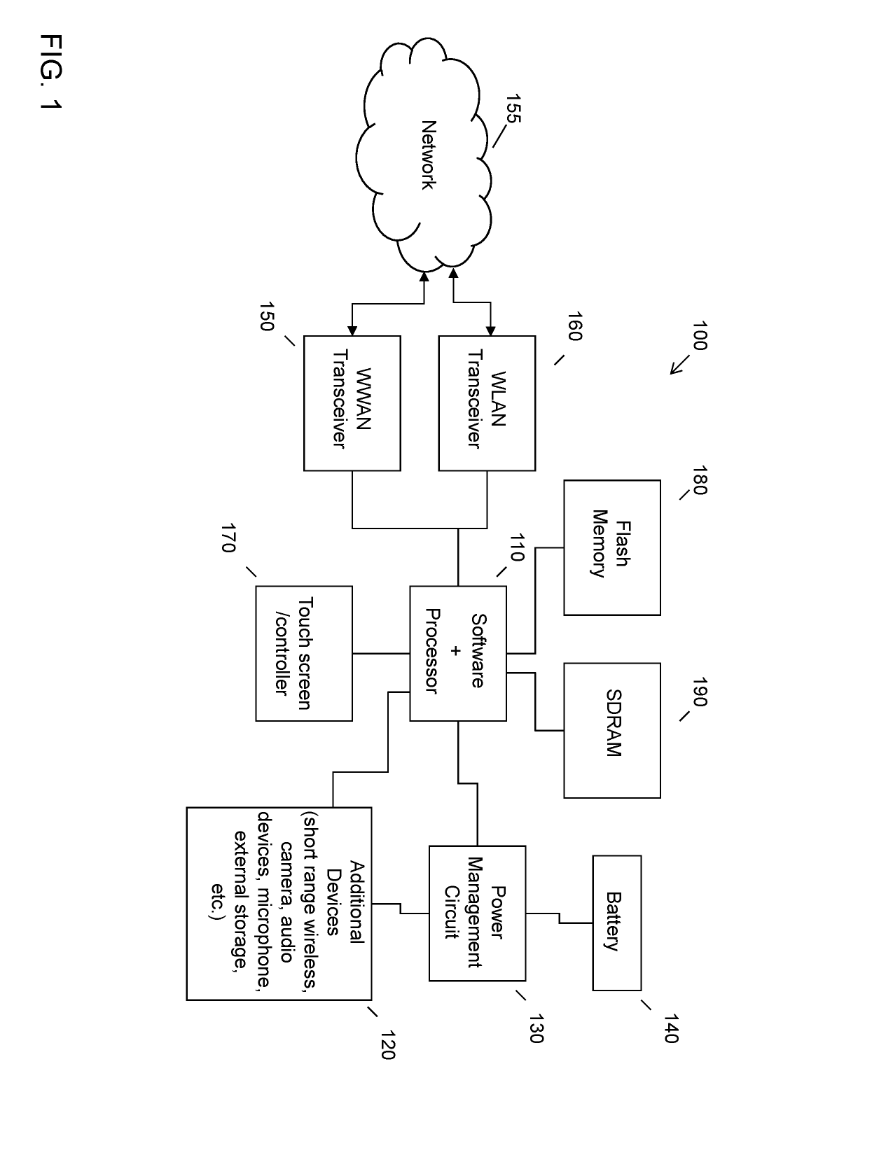

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks 155 (e.g., telecommunications networks, wireless Internet devices (e.g., access points), cloud networks, remote networks, local networks, etc.). Additionally, devices 120 are commonly included, e.g., a wireless communication device, external storage, camera, microphone, external storage, etc. System 100 often includes a touch screen 170 for data input and display/rendering. System 100 also typically includes various memory devices, for example flash memory 180 and synchronous dynamic random-access memory (SDRAM) 190.

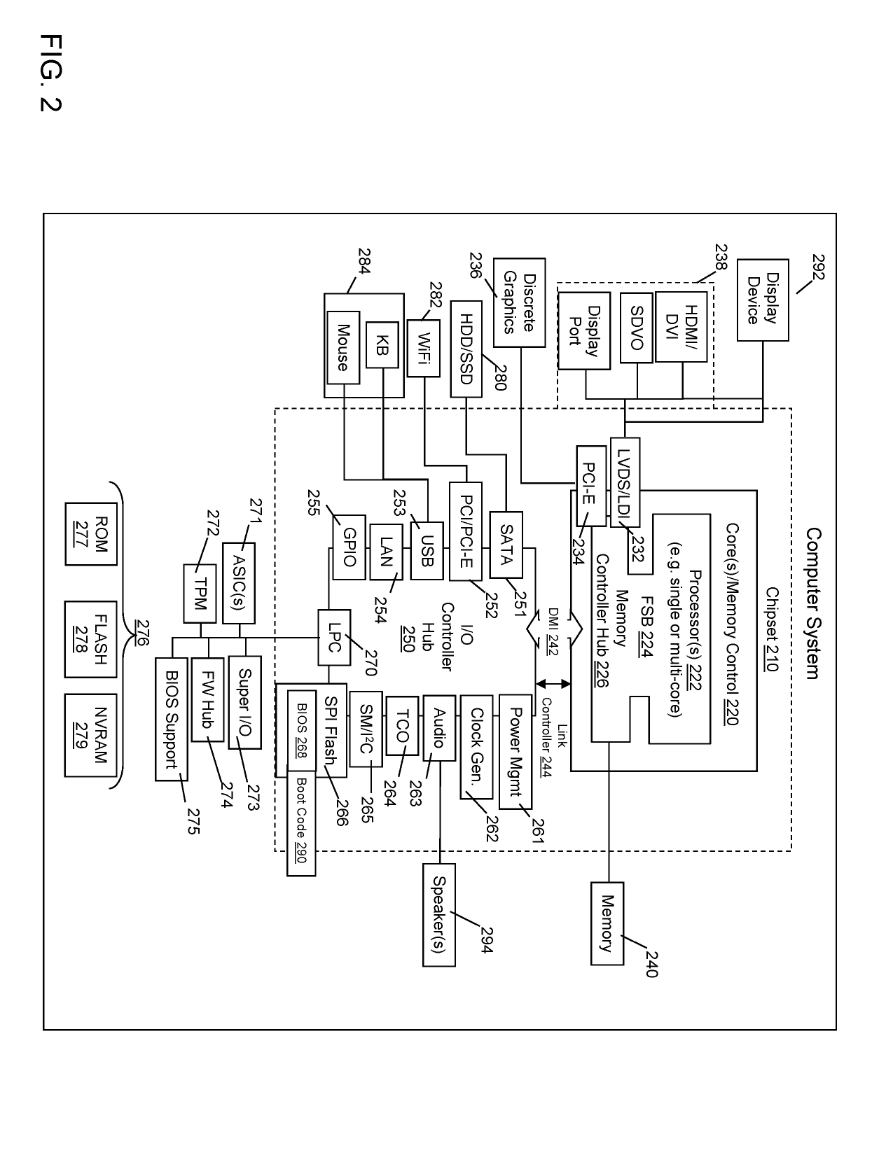

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIGS. 1 or 2, may be used in devices such as tablets, smart phones, personal computer devices generally, and/or electronic devices, which may be devices that are used by users to capture images of components, that analyze components for damage, that house or provide access to the component imaging system, and/or the like. For example, the circuitry outlined in FIG. 1 may be implemented in a tablet or smart phone embodiment, whereas the circuitry outlined in FIG. 2 may be implemented in a personal computer embodiment.

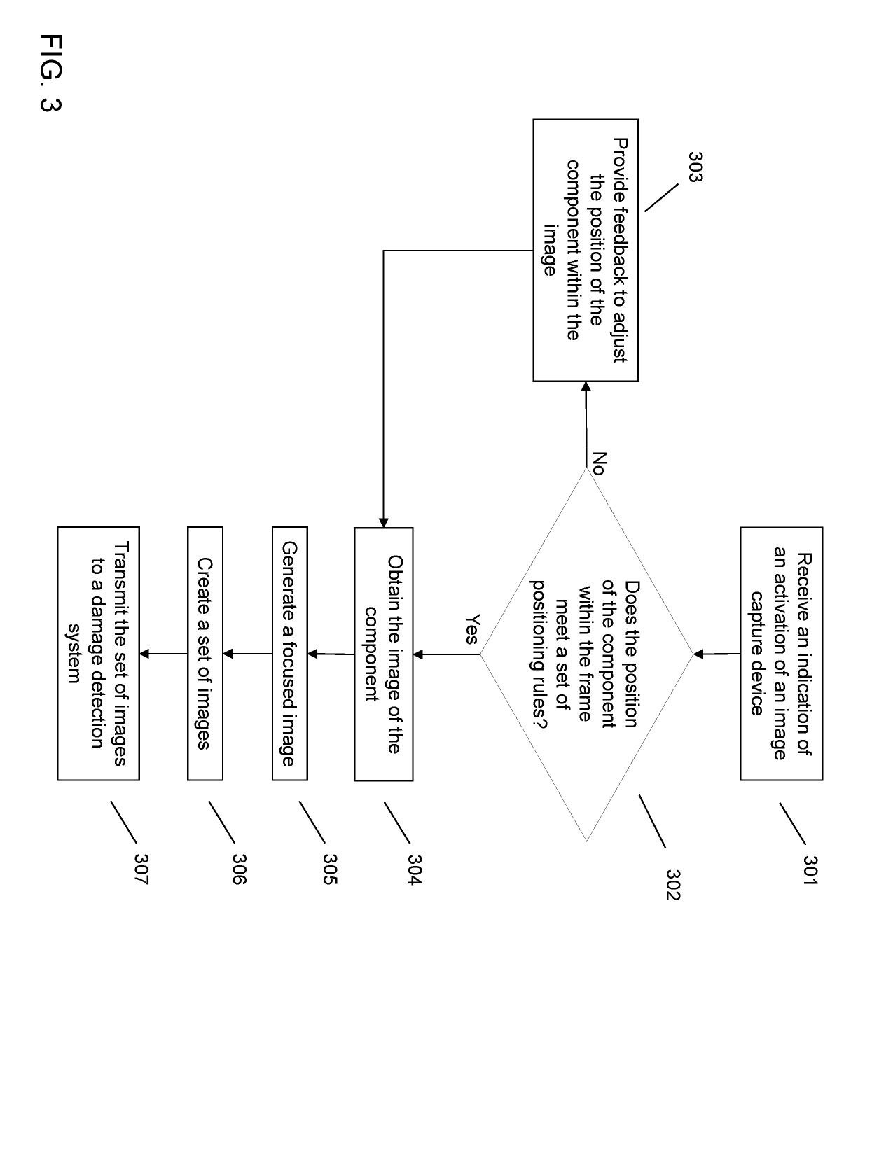

FIG. 3 illustrates an example method for creating a set of images from an image of a component that conforms to positioning rules and that can be transmitted to a damage detection system while maintaining a resolution of the image so that damage of the component can be more accurately detected. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIGS. 1 and/or 2. While the system may include known hardware and software components and/or hardware and software components developed in the future, the system itself is specifically programmed to perform the functions as described herein to create a set of images from an image of a component for damage detection. Additionally, the component imaging system includes modules and features that are unique to the described system.

The component imaging system may be activated in order to create a set of images to be provided to a damage detection system. Thus, the component imaging system may be activated upon detection of the activation of an image capture device, upon detection that an image of a component is to be captured, upon detecting that an image of a component has been obtained and needs to be provided to the damage detection system, and/or the like. Upon activation of the component imaging system, the component imaging system ensures that the image of a component that is obtained fulfills a set of positioning rules. The component image system also generates a focused image to reduce image noise (e.g., reduces a background of the image, eliminates objects other than the component within the image, etc.). From the focused image, the system generates a set of images that maintain the resolution of the obtained image, but ensures that the images are acceptable for the damage detection system such that the damage detection system will not perform additional processing on the images that could reduce the ability of the damage detection system to detect damage of the component.

Activation of the component imaging system may be a manual activation of the component imaging system and/or an automatic activation of the component imaging system. Manual activation of the system may include a user opening an application associated with the component imaging system, the user accessing the computing system associated with the component imaging system, and/or the user otherwise providing input to the component imaging system. The automatic activation of the component imaging system may be based upon the detection of a trigger event indicating that the system should be activated. Example trigger events include the detection of a component within an image capture device preview, detection of the capture or imminent capture of an image of a component, a user accessing an application that interfaces with the component imaging system, activation of software or an application utilizing the component imaging system, and/or the like.

The component imaging system may be made of multiple systems or modules that communicate together to make up the component imaging system or may be a single system. The component imaging system may be a standalone system, may be accessible through other computing devices, and/or a combination thereof. For example, the component imaging system may be a standalone system that can be accessed by a user and/or may be or provide an application that is accessible by a user on another computing device. The component imaging system may be accessible using any type of computing device, for example, personal computer, laptop computer, smartphone, tablet, smartwatch, head-mounted display, smart television or other smart appliance, augmented reality device, virtual reality device, and/or the like.

Thus, the component imaging system may be accessible locally using a computing device where the component imaging system is installed and/or may be accessible remotely through another computing device. For example, the component imaging system may be accessed by a user using a device that communicates with the component imaging system to obtain or provide images of a component, to adjust images to be provided to a damage detection system, and/or the like. However, the component imaging system may be located and operate on a different information handling device to perform the described steps. In other words, the user may access a device housing the component imaging system or may access a device that communicates with a device housing the component imaging system.

The component imaging system can be provided as a service to other entities or companies. In other words, the component imaging system could be stored on a server or network of a company and the system obtain images that are to be provided to a damage detection system, with the other companies or entities paying for component damage detection or use of the component imaging system. For example, a company or user may allow the service provider access to devices that are utilized to capture images of potentially damaged components or access to images of components so that the service provider can create a set of images that can be provided to a damage detection system. Thus, the service provider could provide feedback regarding image positioning, create a set of images, provided a set of images to a damage detection system, and/or the like.

The component imaging system may have an associated graphical user interface. The component imaging system may also display a graphical user interface. The description of the graphical user interface here is a description of a graphical user interface that can be used by a user to adjust the component imaging system, provide input to the component imaging system, and/or the like, and not the graphical user interface that displays the images or a graphical user interface that may be displayed by an image capture device or a device connected to or in communication with the image capture device, for example, to display a preview of an image to be captured. The graphical user interface may be provided on a display or monitor, which may or may not be associated with the component imaging system. In other words, the component imaging system may have a dedicated display or monitor or may be accessible using any display or monitor. In either case, the component imaging system may provide instructions to generate and display the graphical user interface on the display device being used to access the component imaging system. The graphical user interface may also be updated and managed based upon instructions provided by the component imaging system. In other words, the component imaging system generates and transmits instructions to create and update the graphical user interface.

The graphical user interface may include a plurality of tabs, windows, and/or unique interfaces. The graphical user interface may include graphical user interface icons or elements. Graphical user interface icons or elements may include static non-selectable elements (e.g., headers, footers, logos, global information areas, graphics, etc.), dynamic non-selectable elements (e.g., local information areas applying to a specific element, dynamic graphics, information areas that update based upon the information provided therein, indicators, statistics displays, etc.), static selectable elements (e.g., radio buttons, menu icons, selectable indicators, etc.), dynamic selectable elements (e.g., form field input areas, pull-down menus, pop-up windows, etc.), and/or any other elements that may be found in a graphical user interface.

The graphical user interface may allow a user to provide input identifying information to be used by the component imaging system. For example, the component imaging system may utilize a user profile, historical information, and/or the like, to identify whether the position of the component within the frame meets a set of positioning rules, to generate a focused image, to create a set of images, and/or the like. The graphical user interface may allow for creation of or access to these profiles, historical information, and/or the like, by allowing a user to input information regarding user preferences, image preferences, damage detection system settings, and/or the like. As will be discussed in more detail, the use of user provided information is not the only way that the profile and/or historical information can be created. The component imaging system can then utilize these inputs, whether provided directly by the user or identified using a different technique, to create the profile(s), store the historical information, and/or the like.

A user could also use the graphical user interface to adjust information within the profile(s), historical information, and/or the like. Additionally, or alternatively, the user can input a location of information related to one or more of the profiles, historical information, and/or the like, provide a file corresponding to information related to the information, and/or the like, within the graphical user interface. Input may be provided by the user using any type of input modality, including, but not limited to, mechanical input (e.g., keyboard input, mouse input, etc.), touch input, audible or voice input, gesture input, haptic input, thought input, gaze input, electromyography input, virtual or augmented reality input, and/or the like.

The graphical user interface may also provide displays that display information of the profiles, and/or the like. It should be noted that the information to be used by the component imaging system and information provided by the component imaging system can be different for different applications, different computing systems, different users, and/or the like. Thus, the information corresponding to input or output of the component imaging system are not always the same. However, the component imaging system may have default or system-wide settings that are the same across different users, systems, applications, and/or the like, until the information is adjusted or otherwise changed.

It should be noted that different users may configure the graphical user interface per their preferences. Thus, the graphical user interface layout and configuration may be different between users. How much a user can configure the layout may be restricted or set by a system administrator and/or the like. Additionally, different users or different user roles may have different levels of access, which may also change how and what information is displayed. Thus, different graphical user interfaces may be displayed by the system.

The component imaging system may utilize one or more artificial intelligence models in creating a set of images to be transmitted to a damage detection system. Artificial intelligence models may also be used for steps within a step. For example, a model could be utilized to identify how many images should be included within the set of images, to identify the positioning rules that apply to a particular component, to parse an image to identify the background and foreground to generate a focused image, and/or the like.

For ease of readability, the majority of the description will refer to a single artificial intelligence model. However, it should be noted that an ensemble of artificial intelligence models or multiple artificial intelligence models may be utilized. Additionally, the term artificial intelligence model within this application encompasses neural networks, machine-learning models, deep learning models, artificial intelligence models or systems, and/or any other type of computer learning algorithm or artificial intelligence model that may be currently utilized or created in the future.

The artificial intelligence model may be a pre-trained model (e.g., a general model, such as a general classification model) that is fine-tuned for the component imaging system, or the artificial intelligence model may be a model that is created and trained from scratch. Since the component imaging system is used in conjunction with creating a set of images to be transmitted, some models that may be utilized by the system are image analysis models, text analysis models, audio analysis models, analysis models, similarity identification models, language models, large language models, entity identification models, input analysis models, filtering models, classification models, and/or the like. The model may be trained using one or more training datasets.

Additionally, as the model is deployed, it may receive feedback to become more accurate over time. Alternatively, or additionally, the model may utilize inputs provided to the model to learn continually, thereby using the inputs to make subsequent predictions or using the inputs within the subsequent predictions. The feedback or inputs may be automatically ingested by the model as it is deployed. For example, as the model is used to perform the described method, if a user modifies predictions that were made by the model, provides feedback regarding a prediction, or otherwise provides some indication that the predictions or selections made by the model may be incorrect, the model may ingest this feedback to refine the model.

On the other hand, as the model makes predictions in connection with performing the described steps, and no changes are made to the resulting prediction, the model may utilize this as feedback to further refine the model. This may be referred to as reinforcement training where a prediction that was made by the model is reinforced as the correct prediction. Training the model may be performed in one of any number of ways including, but not limited to, supervised learning, unsupervised learning, semi-supervised learning, training/validation/testing learning, and/or the like.

Whether the model automatically ingests feedback during deployment or not may be determined by a user, author, and/or entity that has deployed the model. Automatic learning by the model may be useful in some applications, but may be detrimental in other applications. Accordingly, a user may make a determination regarding the trainability of the model during deployment. Regardless of whether the model can be retrained during deployment or is only retrained upon instruction by a user, the feedback or inputs could be stored within a data store and utilized at a later time to train or retrain the model. For example, a user could use the feedback to update a training dataset to train or retrain the model. The feedback or inputs could also be stored within the data store and then be used by the model for updated training. This may be done, for example, in an unsupervised learning session that allows the model to learn patterns and information regarding the training dataset without the need for human supervision, thereby providing at least a partially automated technique for the model to become updated. However, the model may or may not perform this retraining without a human providing input to the model to perform the retraining. In other words, retraining of the model may be based upon how the model is programmed and whether the model is updated while it is deployed or is only updated during a training mode may be based upon that programming.

As previously mentioned, an ensemble of models or multiple models may also be utilized. Some example models that may be utilized are variational autoencoders, generative adversarial networks, recurrent neural networks, convolutional neural networks, deep neural networks, autoencoders, random forest, decision tree, gradient boosting machine, extreme gradient boosting, multimodal machine learning, unsupervised learning models, deep learning models, transformer models, inference models, and/or the like, including models that may be developed in the future. The chosen model structure may be dependent on the particular task that will be performed with that model. Additionally, the feature sets, vectors, layers, outputs, and/or other characteristics of the model may be chosen by a user based upon the application.

The component imaging system may include different components for carrying out different functions of the system, including different steps to be performed. These components may be hardware components or software components. Some hardware devices or components that may be utilized by the component imaging system include input devices that may be utilized to receive input from the user, for example, mechanical input modalities (e.g., keyboard, mouse, etc.), touch input devices, gesture input devices, electromyography input devices, audio input devices, and/or the like. Other hardware components may be utilized to provide output from the component imaging system. For example, the component imaging system may include speakers, displays or monitors, haptic output devices, audio output devices, and/or the like.

Other hardware components may be included to capture images, for example, an image capture device, screen capture devices, and/or the like. Other hardware components may include data storage devices, including on devices of the user (e.g., mobile device, personal computer, laptop, tablet, smart watch, etc.), devices or components of the component imaging system, and/or the like. The component imaging system may also interface with hardware components of a device. For example, instead of the component imaging system including a display, the component imaging system may provide instructions to display content on a display component of a user device that is employing or communicating with the component imaging system.

One software component may include a data storage location or data repository that stores information related to images, user profiles, components, and/or the like. Information may be stored in the data storage location using any data storage technique. Additionally, the system can access the information stored within the data storage location using any type of querying technique, filtering technique, and/or the like. The information contained within the data storage location may also be organized, for example, grouped by component, grouped by component type, grouped by damage, grouped by component size, and/or the like. The data repository may store information related to components, for example, the focused image, the set of images, and/or the like.

The information within the data repository may be indexed for efficient information retrieval. The information may be stored within the data repository may be indexed based upon an identifier assigned to a component, an identifier assigned to images of a component, an identifier assigned to a person capturing the images, an identifier of a damage detection system for which the images are created, and/or the like. Additionally, the information within the data repository may be categorized or grouped, for example, based upon component, based upon component type, based upon damage detection system, based upon entity for which the images correspond, and/or the like. For example, the component imaging system could identify component types and then store the images and other information within the data repository based upon the component type. The information stored within the data repository may be indexed or grouped based upon multiple identifiers or other characteristics. Using the example above, the images and other information could be stored and indexed based upon the component type and also based upon a specific component. Thus, the data repository can allow for filtering and sorting.

Another software component includes one or more profiles that store information related to components, images, entities, damage detection systems, users capturing images or utilizing the system, and/or the like. The profiles may include preferences or settings corresponding to the profile. For example, a profile corresponding to a damage detection system may identify a size of images that are used by the damage detection system, a resolution for images that are used by the damage detection system, and/or other settings of the damage detection system that may influence how a set of images is created or transmitted to the damage detection system. Information within a profile may be identified through manual input, or may be identified by the component imaging system as the system is utilized and inputs are provided to the system. Thus, the component imaging system can monitor inputs provided at both a device and also at external components. Once inputs have been provided (e.g., manual input, audible input, gesture input, etc.), the component imaging system can store this information or settings within a profile.

The provided inputs may also be inputs that are inferred from other inputs. In other words, the component imaging system can monitor a user, monitor images, and/or the like, to determine that an input is being provided to the system. For example, when receiving an indication of an activation of an image capture device, the component imaging system may monitor user inputs to detect when the user is going to take an image. From this input, the system may determine that the component imaging system should be activated in order to identify whether the set of positioning rules have been met. Thus, the input does not have to be a direct input to the system indicating it should be activated, but rather this indirect input of detecting the user input could trigger the system. As another example, the component imaging system may monitor user movements, facial expressions, gestures, audible input, and/or other inputs, to determine that an image needs to be adjusted or a set of images needs to be created. For example, a user may look at an image that was captured and provide audible input or have a facial expression that would indicate that the images need to be adjusted.

Thus, the component imaging system may monitor a user for inputs other than those inputs provided directly to the component imaging system. Additionally, the inferred inputs do not have to be provided by a user. Thus, the component imaging system may also monitor other components or devices that may provide inputs that would indicate that the component imaging system should perform some function. In inferring or correlating inputs, the system may utilize one or more techniques that allows for the inference or identification of information including, but not limited to, rules engines, artificial intelligence models, correlation techniques, and/or the like. These techniques may take the identified information as input, analyze that input based upon the technique programming, and provide an output related to the desired information. This information may then also be placed within a profile for later access.

Any of the mentioned profiles, or other profiles, may include additional information that may be useful for the component imaging system and may be entered by a user, may be default values, may be learned by the system over time, and/or the like. Thus, profiles can be populated with information manually by a user, entities or companies, and/or the like, or can be populated over time as the system learns more about the user, components, images, entities or companies, and/or the like. For example, a user may manually provide input to a user profile and the system can learn preferences about the user over time and populate the user profile with this learned information.

Learned information may be information learned based upon direct inputs, for example, a user may be presented with a pop-up window in response to a trigger and provide input to the pop-up window. This input can be then populated into a profile. Learned information may also be information learned based upon indirect inputs, for example, a user may provide inputs (e.g., audible inputs, visual inputs, gesture inputs, etc.) that indicate that the user would like to obtain images acceptable to be transmitted to a damage detection system, that the image of a component that was captured is unacceptable for the damage detection system, and/or the like. The system can then aggregate this information to learn information over time. With respect to the described component imaging system, the learned information may include historical information, determinations of when to analyze an image against the set of positioning rules, determinations of how many images to include in a set of images, determinations of how information should be provided to a damage detection system, and/or the like.

At 301, the component imaging system may receive an indication of an activation of an image capture device. The receipt of the indication of the activation may be received prior to the image being captured. The indication of the activation of the image capture device may be a detection of an image capture application being opened, started, or activated on a device that includes an image capture device or that is in communication with an image capture device. The device may be a device that includes more than just the image capture device, for example, a cellular or smart phone, a laptop computer, a tablet, and/or the like, or may be a device that is the image capture device, for example, a web camera, a digital camera, an overhead camera, and/or the like. The application may be on the device itself or may be on a device that is in communication with the image capture device. For example, the application may be installed on the smart phone or may be installed on a computer that communicates with a dedicated image capture device. Upon activating the image capture device application, the system may receive an indication that the application has been activated. This indication may be the indication of the activation of the image capture device.

The indication of the activation may additionally, or alternatively, include additional inputs other than the simple activation of the image capture device. Requiring additional inputs may reduce the amount of processing that the component imaging system performs. However, this is not necessary and the simple activation of the image capture device may act as the indication. One additional input may be detection of a component within a preview of an image to be taken. Thus, the activation may include a preview of an image to be taken of a component. In other words, when the image capture device is activated, a preview of an image may be presented in a view finder, on a display screen, on a connected display, and/or the like. This preview of the image may be presented before the image is captured or obtained. The preview allows a user to adjust a location of an object within the frame of an image to be captured. If the indication of an activation includes the detection of the component, the system may analyze the preview to determine if a component is included in the preview. Detection of the component within the preview may be treated as the indication of the activation of the image capture device.

The indication may be the activation of the image capture device and may also include the detection of a component within the image preview. The indication may alternatively, or additionally, be the detection of a potential user input that would indicate the user is about to capture the image. For example, the system may detect that a finger or fingertip of the user is over the image capture input component. In this example, instead of simply identifying that a component is within the image preview pane, the system also detects that the user is about to capture the image. By detecting the additional input that the user is about to capture the image, the processing required by the system may be reduced so that it not constantly detecting a position of a component within the image preview. However, the detection that the user is about to capture the image is not necessary, as the component imaging system may simply detect that the image capture device has been activated and/or that the component is within the image preview.

Other techniques for receiving an indication of the activation of the image capture device are contemplated and possible. Additionally, a combination of techniques may be possible. Other techniques may include detection of activation of the damage detection system in addition to the detection of the image capture device, detection of the image capture device being in a particular location (e.g., installed on a stand that is dedicated to capturing images of components, located within a building corresponding to component damage detection, being within a predetermined distance from a workstation or work space, etc.), detection of activation of the component image system, and/or the like. It should also be noted that the indication of the activation of the image capture device may act as a trigger to activate the component imaging system. The indication of the activation of the image capture device and any other inputs or techniques may result in a signal being transmitted to the component imaging system. This signal may notify the component imaging system that the image capture device has been activated.

At 302, the component imaging system may determine if the position of the component within the frame meets a set of positioning rules. In other words, the component imaging system may identify whether a position of the component within a frame of the preview meets a set of positioning rules. This determination may be performed before an image of the component is captured or obtained. The system may analyze the preview image to identify objects within the preview image. The analysis to identify objects within the preview image may be performed using an artificial intelligence model, object identification image analysis, localization techniques or algorithms, and/or other image parsing and analysis techniques. It should be noted that the identification of the objects within the image preview and determination of whether the position of the component meets the set of positioning rules are background processes, meaning that the different processing steps are not displayed in the preview image. However, one or more of the processing steps or results thereof could be displayed if desired or helpful in particular applications.

Once objects within the preview image have been identified, the system may identify a main or focus object within the preview image. This analysis may be performed using one or more image parsing and/or analysis techniques, for example, those previously mentioned. To identify the main or focus object, the system may parse the image to identify background and foreground objects. Objects within the background may be discarded by the system as being main or focus objects, thereby leaving those objects within the foreground as potential main or focus objects. The system may additionally, or alternatively, identify main or focus objects based upon an identification of the object, which may be a specific identification of the object or may be a classification of the object into a category.

In identifying a main or focus objects, the system may utilize object localization. Object localization may work by identifying and locating the most visible object within the image as opposed to finding all objects within the image. However, the system may also find all objects within the image and then discard objects as non-focus objects. In object localization, the component imaging system may identify the main or focus object and the location of the object within the image by putting a bounding box around the object. This bounding box may not be displayed on the image preview, but may rather be a background processing technique. Other techniques other than bounding boxes can be utilized, for example, instance segmentation, semantic segmentation, and/or the like. In addition to identifying the object boundaries, the system may extract features from the objects to identify the objects within the scene. Identification of the objects may also be utilized to identify the main or focus object. For example, if an object has been identified as a component, the system may determine that it is the focus or main object. On the other hand, if an object has been identified as a pencil, the system may determine that it is not the focus or main object.

Object localization can include one or more localization techniques, for example, a thresholding method, an edge detection method, pixel analysis method, and/or the like. It should be understood that many other techniques for object localization exist and can be utilized either alone or in combination with other techniques. Thus, the described methods are merely examples and are not intended to limit this disclosure to only those methods. In the thresholding method, the component imaging system converts the image in the image preview to a black-and-white image. The system then adjusts contrast, focus, and other characteristics of the image to result in an image where the main component is substantially the only object left within the image. The system can then establish a bounding box around this object. The system may increase the size of the bounding box to include a predetermined threshold distance around the object in order to ensure that the entire component is captured by the bounding box.

In the edge detection method, the system identifies the edge of the object within the preview image. This may include converting the image to a simple line black and white image (which may include adjusting contrast, sharpness, and/or other image characteristics), and then identifying the position of the outermost line to determine the edges. The bounding box can then be drawn where the edges have been detected. The system may also use a pixel analysis which identifies a difference between adjacent pixels or adjacent pixel groups to identify edges of the object. Other object localization techniques can be utilized or a combination of techniques may also be utilized.

Once the main or focus object has been detected and identified as the component, the system may compare the location and position of the component to the set of positioning rules. The positioning rules may identify how the component should be located within the image preview, may identify how far from the image capture device the component should be, and/or the like. The set of positioning rules may be set up as a series of rules to which the preview image and component within the preview image are compared. The rules may include rules related to a distance of the component from the image, an amount of background captured within the image preview, a tilt or angle of the component within the image preview, a size of the component within the image preview, a position of the component within the preview (e.g., how much of the component is captured, whether the component is centered within the preview, whether there is a threshold distance between an edge of the component and the edge of the image preview, etc.), and/or the like.

A few of the positioning rules will be discussed as examples. However, it should be noted that other positioning rules are contemplated and possible. As a first example positioning rule, the positioning rule may identify that the component should be positioned within the frame of the preview such that the entire component can be captured in an image. To determine if the entire component has been captured in the image, the system may compare the edge of the component (or edge of the bounding box) to the edge of the frame. The system may determine the distance between the edge of the component to the edge of the frame. This distance may then be compared to a predetermined threshold distance. If the distance is greater than or equal to the predetermined threshold distance, then the component fulfills the positioning rule. If, on the other hand, if the distance is less than the predetermined threshold distance, then the component does not fulfill the positioning rule. For example, if the entirety of the component is not captured within the image preview, then at least one of the distances between the edge of the component and the edge of the frame will be a distance of zero. This may be less than the predetermined threshold distance. The predetermined distance may be a distance input by a user, learned by the system over time, a default value, and/or the like.

As a second example positioning rule, the positioning rule may identify that the component needs to be at least a particular size, so that the details of the component can be accurately captured in the image. To determine if the component is at least the particular size within the image, the system may compare the size of the component to a predetermined or threshold size. If the size of the component within the image is at least the predetermined or threshold size, then the component fulfills the positioning rule. If, on the other hand, the size of the component within the image is does not meet the predetermined or threshold size, then the component does not meet the positioning rule.

As a final, non-limiting example positioning rule, the positioning rule may identify that the component needs to have a particular angle with respect to the frame, so that the details of the component can be captured, so that there is no glare on portions of the component, so that specific details of the component can be captured, and/or the like. To determine if the component is within a threshold to the angle, the system may compare a shape of the bounding box or outer edges of the component to a predetermined shape. Alternatively, or additionally, from the angles in the shape, the system can determine an angle of tilt of the image capture device with respect to the component. This angle of tilt can then be compared to the predetermined angle or threshold range of the predetermined angle.

When an image is taken at an angle or with tilt, the shape of the object will change, particularly when looking at the edges of the object. For example, an object that has a rectangular shape, when captured at an angle will result in a trapezoid shape of the outer edges of the object. Thus, a system can tell from this shape that the image was taken at an angle. Additionally, using this trapezoid example, a calculation of the angle between a top and/or bottom edge of the trapezoid and a side edge can be correlated to an amount of angle or tilt of the image capture device when the image was captured. If the angle of the component with respect to the frame is less than or equal to the threshold angle or tilt, then the component fulfills the positioning rule. If, on the other hand, angle of the component with respect to the frame is greater than the threshold angle or tilt, then the component does not meet the positioning rule. Other positioning rules are contemplated and possible.

It should be noted that the set of positioning rules may be different based upon different factors, for example, characteristics of the component (e.g., size, shape, component type, complexity of the component, etc.), requirements of the damage detection system, requirements of an entity obtaining the image, the type or amount of damage to the component, and/or the like. Thus, the set of positioning rules may vary between different image captures of components. Accordingly, the positioning rules can be dynamic and based upon the different factors. For example, a positioning rule related to a size of the component within the image may vary based upon a complexity of the component. As another example, a positioning rule related to a size of the component may vary based upon resolution requirements of the damage detection system to which the images will be transmitted. As another, non-limiting example, a positioning rule related to the predetermined threshold distance between an edge of the component and edge of the frame may vary based upon a physical size of the component or a component type. Thus, not only can the set of positioning rules vary, but also any thresholds or comparison values can vary based upon the different factors.

If the component within the frame does not meet the set of positioning rules at 302, the component imaging system may provide feedback to adjust the position of the component within the image or frame at 303. To provide feedback, the component imaging system may utilize an output component. Output components may include, but are not limited to, displays or other visual output devices or components, audio output devices or components, haptic output devices or components, lights, and/or the like. The feedback may be presented in one or more forms. Additionally, a combination of feedback can be utilized. Some types of feedback may include, but are not limited to, pop-up notifications, display overlays, colored overlays, audible output, haptic output, flashing lights, and/or the like.

The feedback may include directive feedback which provides directions to the user to adjust the component within the frame. The feedback may also, or alternatively, identify information related to the positioning rule or rules that are not fulfilled by the component within the frame, information related to how to adjust the component within the frame (either by adjusting the component or the image capture device) to make the component within the frame fulfill the positioning rules, and/or the like. The user may then make changes to the adjust the component within the frame based upon the feedback.

Once the component within the frame fulfills the set of positioning rules either after adjusting the component in response to the feedback provided at 303 or because the system determines that the position of the component meets the set of positioning rules at 302, the component imaging system may obtain the image of the component at 304. In obtaining the image, the image capture device may be activated to capture the image of the component within the frame. Once the image capture device has captured the image, the image may be obtained by the component imaging system. Obtaining the image may be performed using any type of information obtainment technique including, but not limited to, saving the image in an accessible file location, transmitting the image to the component imaging system, saving the image to a data storage location and providing a link or pointer to the data storage location to the component imaging system, and/or the like.

At 305, the component imaging system generates a focused image from the image that was obtained at 304. To generate the focused image, the component imaging system removes image noise from the image. The image noise refers to the background of the image or parts of the image that are not the focus object. The image noise are the parts of the image that do not correspond to the focus object, thereby creating unwanted parts of the image, referred to as noise. Some examples of image noise may include the background, other objects within the image, image defects, lens dust, and/or the like. To remove the image noise, the system may utilize one or more image noise reduction techniques, including image processing, image filtering, and/or the like. Other techniques for removing or reducing image noise are contemplated and possible. Additionally, a combination of techniques may be utilized.

To remove or reduce the background, the system may crop the image so that no more than a predetermined amount of the background remains. In other words, the system may crop the image to within a predetermined distance of the component within the frame. Thus, the system may have a predetermined distance that is set between the edge of the component within the frame and the edge of the frame. As with the set of positioning rules, the predetermined distance may vary based upon the different factors, user or entity preferences, and/or the like. The system may then crop the image based upon or to this predetermined distance, thereby leaving an amount of background that corresponds to the predetermined distance between the edge of the component and the edge of the frame. To remove or reduce the background, the system may also perform image processing that can remove or change the background, for example, by changing it to a solid color, changing it to a predetermined pattern or texture, blurring the background, removing distracting objects within the background, and/or the like.

Once the focused image has been generated at 305, the component imaging system creates a set of images at 306. Each of the images within the set of images includes a portion of the focused image. While some of the images may include information that overlaps with other of the images within the set of images, each of the images within the set of images may include unique portions of the focused image, or may have very little overlap between images of the set of images. The set of images includes the total component. In other words, regardless of overlap between the images within the set of images, none of the component will be missing from the total set of images, even though individual of the images within the set of images includes less than the whole component.

The set of images are images that will be transmitted to the damage detection system. The damage detection system may have requirements for images that are obtained by or transmitted to the damage detection system. These requirements may result in images being rescaled or resized, which can affect the resolution of the image of the component. Accordingly, by splitting the focused image into a set of images, the component imaging system can ensure that a resolution of the images is maintained, thereby maintaining the detail captured within the image. Additionally, by splitting the focused image into a set of images, the requirements of the damage detection system for the images can be fulfilled. Thus, when creating the set of images, the number of images that are included in the set of images may be a number that ensures the resolution and/or detail of the focused image is maintained while making the images conform to the requirements of the damage detection system.

To determine the number of images to include within the set of images, the system may utilize an artificial intelligence model that is trained on components and damage detection system requirements. This artificial intelligence model can then take the focused image and select the number of images that are required in order to maintain the resolution of the focused image and increase a size of each of the images within the set of images so that they conform with the requirements of the damage detection system. Determining the number of images to include within the set of images may also be accomplished using other techniques. For example, the number of images within the set of images can be based upon factors of the focused image. These factors may include a complexity of component, a size of the component, a size of the damage, contrast between different portions of the component, and/or the like.

Once a number of the set of images has been identified, the system can split the image into the selected number of images to create the set of images. Splitting the image into the number of images may include cropping the focused image into the different images, cutting the focused image into the different images, and/or any other type of image splitting technique. These images can then be stored together, or otherwise tagged so that they are kept together or identified as belonging to the same set of images, so that the images are notated as belonging to the same set of images.

Once the set of images have been created at 306, the component imaging system can transmit the set of images to a damage detection system at 307. The set of images can be transmitted using any file or image transmission technique, including a direct transmission of the set of images, a transmission of the set of images to a data repository accessible by the damage detection system, a transmission of a file pointer or link to the set of images, and/or the like. The damage detection system can then analyze the images to detect damage on the component. Additionally, the damage detection system may be able to identify a cause of the damage.

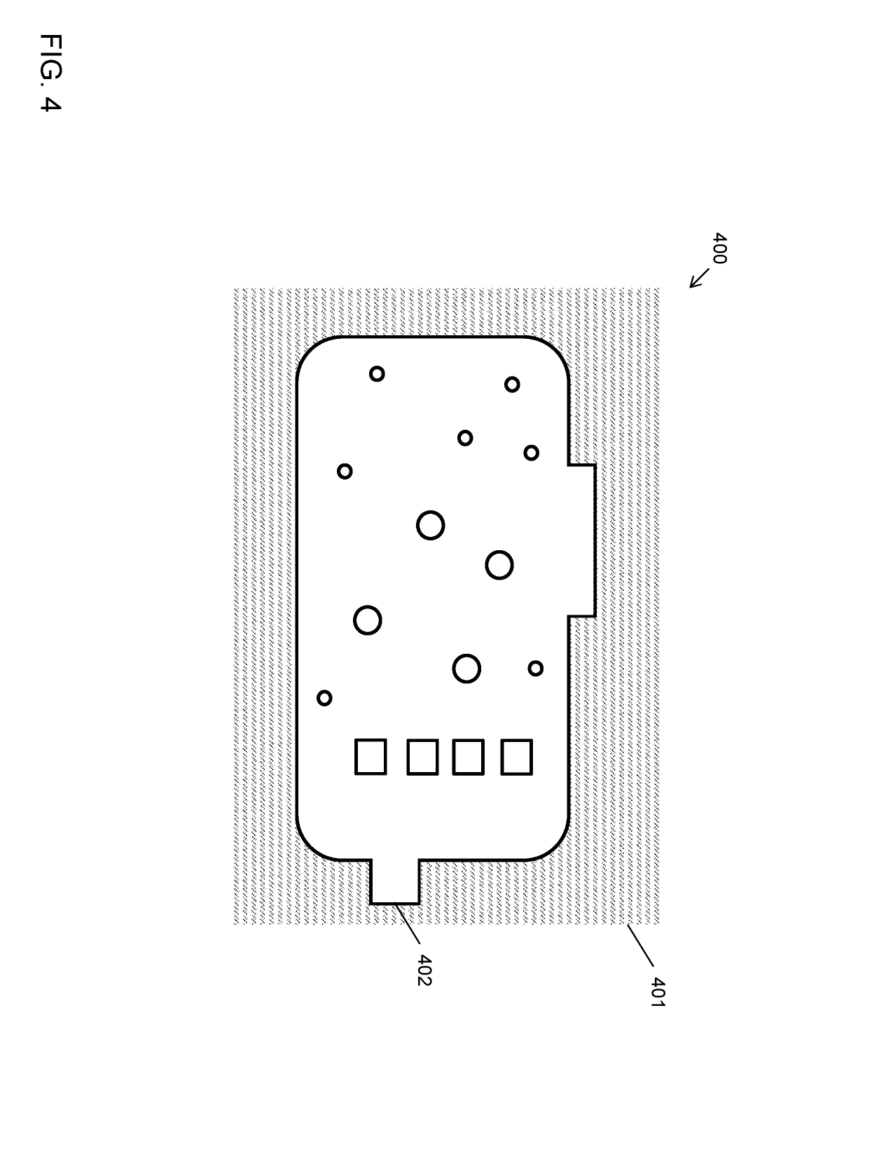

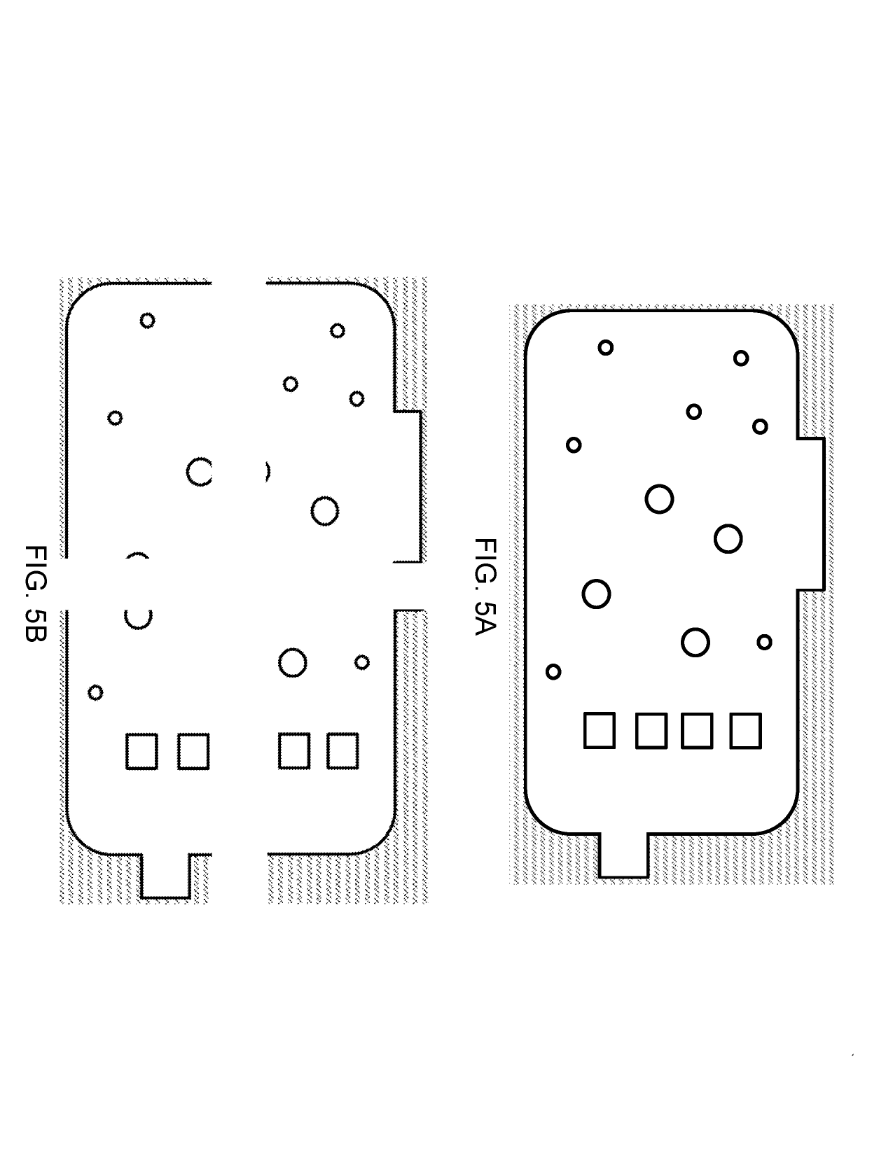

As an overall, a non-limiting example is illustrated in FIGS. 4 and 5A and 5B. In this example, a technician is capturing images of a component to be transmitted to a damage detection system. The technician activates an image capture device to capture the image of the component on a background. After adjusting the image capture device and component within the frame based upon feedback received from the component imaging system, the technician takes an image of the component that is then obtained by the component imaging system. FIG. 4 illustrates an example image 400 that was captured of the component 402 on a background 401. Once the image 400 has been obtained, the component imaging system generates a focused image, illustrated in FIG. 5A. As seen in this focused image, the image has been cropped in order to remove a portion of the background. The component imaging system then creates a set of images, for example, as illustrated in FIG. 5B. In this example, the set of images include four images, with each image corresponding to a different quadrant of the focused image. This set of images maintains the resolution of the original image 400, while ensuring that the size of each image corresponds to the size requirements of the damage detection system. Each of the images within the set of images can then be transmitted to the damage detection system for damage analysis.

It will be readily understood that the components of the embodiments, as generally described and illustrated in the figures herein, may be arranged and designed in a wide variety of different configurations in addition to the described example embodiments. Thus, the more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
receiving, at a component imaging system, an indication of an activation of an image capture device, wherein the activation comprises a preview of an image to be taken of a component;
obtaining, responsive to identifying that the position of the component within the frame meets a set of positioning rules, the image of the component;
generating, using the component imaging system, a focused image by cropping the image;
creating, using the component imaging system, a set of images, each of the images within the set of images including a respective portion of the focused image that is omitted from other images of the set of images; and
transmitting, using the component imaging system, the set of images to a damage detection system.

2. The method of claim 1, comprising, responsive to identifying that the position of the component within the frame does not meet the set of positioning rules, providing, using an output component, feedback regarding the position of the component within the frame.

3. The method of claim 1, comprising identifying whether a position of the component within a frame of the preview meets a set of positioning rules, wherein the identifying comprises identifying the component within a frame of the preview and determining a distance of the component from at least one edge of the frame.

4. The method of claim 1, comprising identifying whether a position of the component within a frame of the preview meets a set of positioning rules, wherein the identifying comprises identifying a size of the component within the frame.

5. The method of claim 1, comprising identifying whether a position of the component within a frame of the preview meets a set of positioning rules, wherein the identifying comprises identifying an angle of the component with respect to the frame.

6. The method of claim 1, wherein the set of positioning rules is different based upon characteristics of the component.

7. The method of claim 1, wherein the generating comprises cropping the image to within a predetermined distance of the component within the frame.

8. The method of claim 1, wherein the creating comprises dividing the focused image into the set of images to preserve detail within the focused image.

9. The method of claim 8, wherein the dividing comprises identifying a number of images within the set of images based upon factors of the focused image.

10. The method of claim 1, wherein the creating comprises utilizing an artificial intelligence model to determine a number of images within the set of images to maintain a resolution of the focused image and increase a size of each of the images within the set of images.

11. A system, the system comprising:
a processor;
a memory device that stores instructions that, when executed by the processor, causes the system to:
receive, at a component imaging system, an indication of an activation of an image capture device, wherein the activation comprises a preview of an image to be taken of a component;
obtain, responsive to identifying that the position of the component within the frame meets a set of positioning rules, the image of the component;
generate, using the component imaging system, a focused image by cropping the image;
create, using the component imaging system, a set of images, each of the images within the set of images including a respective portion of the focused image that is omitted from other images of the set of images; and
transmit, using the component imaging system, the set of images to a damage detection system.

12. The system of claim 11, comprising, responsive to identifying that the position of the component within the frame does not meet the set of positioning rules, providing, using an output component, feedback regarding the position of the component within the frame.

13. The system of claim 11, comprising identifying whether a position of the component within a frame of the preview meets a set of positioning rules, wherein the identifying comprises identifying the component within a frame of the preview and determining a distance of the component from at least one edge of the frame.

14. The system of claim 11, comprising identifying whether a position of the component within a frame of the preview meets a set of positioning rules, wherein the identifying comprises identifying a size of the component within the frame.

15. The system of claim 11, wherein the set of positioning rules is different based upon characteristics of the component.

16. The system of claim 11, wherein the generating comprises cropping the image to within a predetermined distance of the component within the frame.

17. The system of claim 11, wherein the creating comprises dividing the focused image into the set of images to preserve detail within the focused image.

18. The system of claim 17, wherein the dividing comprises identifying a number of images within the set of images based upon factors of the focused image.

19. The system of claim 11, wherein the creating comprises utilizing an artificial intelligence model to determine a number of images within the set of images to maintain a resolution of the focused image and increase a size of each of the images within the set of images.

20. A product, the product comprising:
a computer-readable storage device that stores executable code that, when executed by a processor, causes the product to:
receive, at a component imaging system, an indication of an activation of an image capture device, wherein the activation comprises a preview of an image to be taken of a component;
obtain, responsive to identifying that the position of the component within the frame meets a set of positioning rules, the image of the component;
generate, using the component imaging system, a focused image by cropping the image;
create, using the component imaging system, a set of images, each of the images within the set of images including a respective portion of the focused image that is omitted from other images of the set of images; and
transmit, using the component imaging system, the set of images to a damage detection system.
